(19) United States
(12) Patent Application Publication
(10) Pub. No.: US 2026/0065402 A1
(43) Pub. Date: Mar. 5, 2026

(54) DISPLAY ASSEMBLY DEVICE AND METHOD

(71) Applicant: Samsung Display Co., LTD., Yongin-si (KR)

(72) Inventors: Yong An LEE, Yongin-si (KR); Dae Ho YANG, Yongin-si (KR)

(21) Appl. No.: 19/017,254

(22) Filed: Jan. 10, 2025

(30) Foreign Application Priority Data
Aug. 27, 2024 (KR) 10-2024-0114767

(51) Int. Cl. G06T 1/00; B32B 37/00; B32B 38/18

(52) U.S. Cl. CPC G06T 1/0014; B32B 37/025; B32B 38/1841; B32B 2457/20

(57) ABSTRACT

A display assembly device includes: a body mount stage extending in a width direction; and a first wing mount stage and a second wing mount stage which are positioned in front of the body mount stage and spaced apart from each other in the width direction, wherein each of the body mount stage, the first wing mount stage, and the second wing mount stage includes: a mount stage base; and a mount stage stand including a mount stage stand body movably coupled to the mount stage base, wherein the mount stage stand includes a mount stage stand hole recessed on an upper face of the mount stage stand body.

### CROSS-REFERENCE TO RELATED APPLICATION

The present application claims priority to and the benefit of Korean Patent Application No. 10-2024-0114767, filed on August 27th, 2024, in the Korean Intellectual Property Office, the entire disclosure of which is incorporated herein by reference.

### BACKGROUND

Aspects of some embodiments relate to a display assembly device and method.

In a process of assembling a display, each material constituting the display can be combined. In this process, it may be desirable to align the materials based on their shapes.

The above information disclosed in this Background section is only for enhancement of understanding of the background and therefore the information discussed in this Background section does not necessarily constitute prior art.

### SUMMARY

Aspects of some embodiments of the present disclosure include a display assembly device and method for aligning materials based on shapes of the materials.

Aspects of some embodiments of the present disclosure include a display assembly device comprising a body mount stage extending in a width direction; and a first wing mount stage and a second wing mount stage which are positioned in front of the body mount stage and spaced apart from each other in the width direction, wherein each of the body mount stage, the first wing mount stage, and the second wing mount stage includes a mount stage base, and a mount stage stand including a mount stage stand body movably coupled to the mount stage base, and the mount stage stand includes a mount stage stand hole recessed on an upper face of the mount stage stand body.

According to some embodiments, the mount stage stand may include a mount stage stand suction port that is recessed on an outer face of the mount stage stand body and communicates with the mount stage stand hole.

According to some embodiments, the mount stage stand may be movably coupled to the mount stage base translationally.

According to some embodiments, the mount stage stand may be rotationally coupled to the mount stage base.

According to some embodiments, the mount stage stand may be coupled to the mount stage base to enable a rotation in at least one of a roll direction, a yaw direction, or a pitch direction.

According to some embodiments of the present disclosure, a display assembly device includes a mount assembly; a sensor unit positioned above the mount assembly; and a control unit connected to the mount assembly and the sensor unit, wherein the mount assembly includes a body mount stage extending in a width direction, and a first wing mount stage and a second wing mount stage positioned in front of the body mount stage and spaced apart from each other in the width direction, and the control unit controls the mount assembly based on a sensing signal received from the sensor unit.

According to some embodiments, the sensor unit may include a camera facing the mount assembly.

According to some embodiments, a material of a film shape may be loaded on an upper face of the mount assembly, and the material may include a material body extending in the width direction, and a first material wing and a second material wing which extend forward from a front end of the material body and are spaced apart from each other.

According to some embodiments, the body mount stage may support the material body, the first wing mount stage may support the first material wing, and the second wing mount stage may support the second material wing.

According to some embodiments, a lower face of the material may face the upper face of the mount assembly, and the material may include a material mark marked on an upper face of the material. The material mark may include a first material mark marked on an upper face of the first material wing, and a second material mark marked on an upper face of the second material wing.

According to some embodiments, the camera may obtain an image of the material mark.

According to some embodiments, the control unit may control the mount assembly based on a difference between the image of the material mark and a reference image.

According to some embodiments of the present disclosure, in a display assembly method, the method includes mounting a material of a film shape on a mount assembly; aligning the material; and transferring the material, wherein the mount assembly includes a body mount stage extending in a width direction, and a first wing mount stage and a second wing mount stage which are positioned in front of the body mount stage and spaced apart from each other in the width direction.

According to some embodiments, the material may include a material body extending in the width direction and supported by the body mount stage in the mounting of the material, a first material wing extending forward from a front end of the material body and supported by the first wing mount stage in the mounting of the material, and a second material wing extending forward from the front end of the material body and supported by the second wing mount stage in the mounting of the material.

According to some embodiments, the first material wing and the second material wing may be arranged in the width direction and spaced apart from each other.

According to some embodiments, a lower face of the material in the mounting of the material may face an upper face of the mount assembly, and the material may include a material mark marked on an upper face of the material. The material mark may include a first material mark marked on an upper face of the first material wing, and a second material mark marked on an upper face of the second material wing.

According to some embodiments, aligning the material may comprise obtaining, by a camera, an image of the material, determining, by a control unit, whether an alignment state of the material is good, and controlling, by the control unit, the mount assembly to align the mount assembly.

According to some embodiments, the control unit may determine that the alignment state of the material is not good when a difference between the image of the material and a reference image exceeds a reference difference, in case of determining whether the alignment state of the material is good.

According to some embodiments, the control unit may perform aligning the mount assembly based on the difference when it is determined that the alignment state of the material is not good.

According to some embodiments, the control unit may end aligning the material when it is determined that the alignment state of the material is good.

A display assembly device according to some embodiments of the present disclosure can align materials based on shapes of the materials.

### BRIEF DESCRIPTION OF THE DRAWINGS

The accompanying drawings, which are included to provide a further understanding of embodiments according to the present disclosure and are incorporated in and constitute a part of the disclosure, illustrate embodiments of the disclosure and together with the description serve to explain the principle of the disclosure.

FIG. 1 illustrates a display assembly.

FIG. 2 illustrates a cross section of a display assembly illustrated in FIG. 1 taken along A1-A2.

FIG. 3 illustrates a material.

FIG. 4 is a plan view of a mount assembly according to some embodiments of the present disclosure.

FIG. 5 illustrates a cross section of a mount assembly illustrated in FIG. 4 taken along B1-B2.

FIG. 6 illustrates that a material illustrated in FIG. 3 is on a mount assembly illustrated in FIG. 4.

FIG. 7 illustrates that a PNP unit transfers a material and arranges the material on a display substrate.

FIG. 8 is a block diagram of a display assembly device according to some embodiments of the present disclosure.

FIG. 9 is a flow chart illustrating aspects of a display assembly method according to some embodiments of the present disclosure.

FIG. 10 is a flow chart illustrating further details of a material alignment operation illustrated in FIG. 9.

### DETAILED DESCRIPTION

In the present disclosure, an XYZ coordinate system as a cartesian coordinate system may be displayed in the drawings. For example, a positive Z-axis direction may indicate an upward direction, and a negative Z-axis direction may indicate a downward direction. For example, a positive Y-axis direction may indicate a forward direction, and a negative Y-axis direction may indicate a rearward direction. For example, a positive X-axis direction may indicate a right direction, and a negative X-axis direction may indicate a left direction.

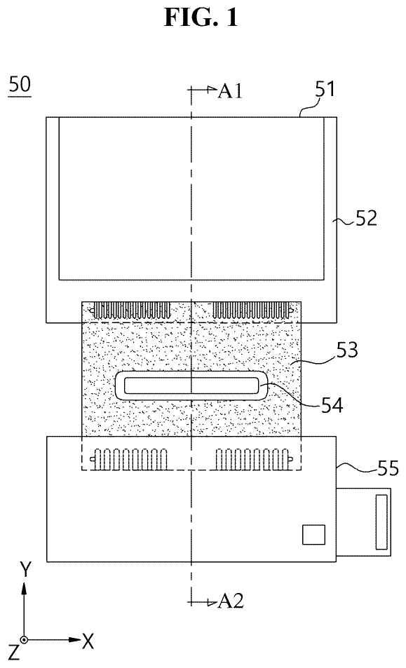

FIG. 1 illustrates a display assembly. FIG. 2 illustrates a cross section of a display assembly illustrated in FIG. 1 taken along the line A1-A2.

Referring to FIGS. 1 and 2, a display assembly 50 may include a display panel 51. The display panel 51 may include a plurality of pixels. The display panel 51 may display images or video.

The display assembly 50 may include a display substrate 52. The display substrate 52 may be coupled to the display panel 51. The display substrate 52 may support the display panel 51. For example, the display substrate 52 may be formed of glass or a polymer material.

The display assembly 50 may include a film substrate 53 and a display driver chip 54. The display driver chip 54 may be coupled to the film substrate 53.

The display driver chip 54 may be connected to the display panel 51 and drive the display panel 51. For example, the display driver chip 54 may be connected to the display panel 51 through the film substrate 53.

The film substrate 53 may form a film shape. The film substrate 53 may be coupled to the display substrate 52. The film substrate 53 may be electrically connected to the display panel 51. The film substrate 53 may be flexible. An electric circuit may be formed on the film substrate 53.

The display assembly 50 may include a flexible printed circuit board (FPCB) 55. The FPCB 55 may be coupled to the film substrate 53. For example, an end of the film substrate 53 may be coupled to the display substrate 52, and another end of the film substrate 53 may be coupled to the FPCB 55.

The FPCB 55 may receive an electric signal from the outside. The electric signal received by the FPCB 55 may be transmitted to the display driver chip 54 via the film substrate 53. The display driver chip 54 may drive the display panel 51 in response to the electric signal.

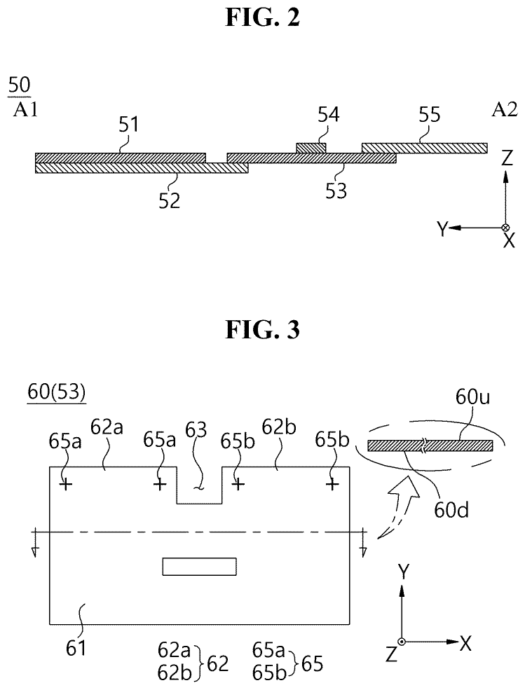

FIG. 3 illustrates a material.

Referring to FIG. 3, a material 60 may include a portion of the display assembly 50 (see FIGS. 1 and 2). For example, the material 60 may include or indicate the film substrate 53 (see FIGS. 1 and 2). A shape of the material 60 may be formed differently depending on the design and function of the display assembly 50 (see FIGS. 1 and 2).

The material 60 may form a shape of a film or a sheet. For example, a material upper face 60u may indicate an upper face of the material 60 and may be directed or face upward. For example, a material lower face 60d may indicate a lower face of the material 60 and may be directed or face downward.

The material 60 may include a material body 61. The material body 61 may form a polygonal shape. For example, a perimeter of the material body 61 may be a tetragon.

The material 60 may include a material wing 62. A plurality of material wings 62 may be provided. For example, the material 60 may include a first material wing 62a and a second material wing 62b. The material wing 62 may include or indicate at least one of the first material wing 62a or the second material wing 62b.

The material wing 62 may protrude or extend in one direction from the material body 61. For example, the material wing 62 may extend forward from a front end of the material body 61. A direction in which the material wing 62 extends from the material body 61 may be a longitudinal direction of the material 60.

The first material wing 62a and the second material wing 62b may be spaced apart from each other. For example, a notch portion 63 may be formed between the first material wing 62a and the second material wing 62b. For example, the notch portion 63 may indicate a gap formed between the first material wing 62a and the second material wing 62b.

For example, the first material wing 62a, the notch portion 63, and the second material wing 62b may be arranged sequentially. For example, a direction in which the first material wing 62a, the notch portion 63, and the second material wing 62b are arranged may be a width direction of the material 60. For example, the material body 61 may extend in the width direction of the material 60.

The material 60 may include a material mark 65. The material mark 65 may be marked on the material wing 62. For example, the material mark 65 may be marked on the material upper face 60u of the material wing 62. The material mark 65 may include or indicate at least one of the first material mark 65a or the second material mark 65b.

For example, a first material mark 65a may be marked on the material upper face 60u of the first material wing 62a. For example, a plurality of first material marks 65a may be arranged in the width direction on the material upper face 60u of the first material wing 62a.

For example, a second material mark 65b may be marked on the material upper face 60u of the second material wing 62b. For example, a plurality of second material marks 65b may be arranged in the width direction on the material upper face 60u of the second material wing 62b.

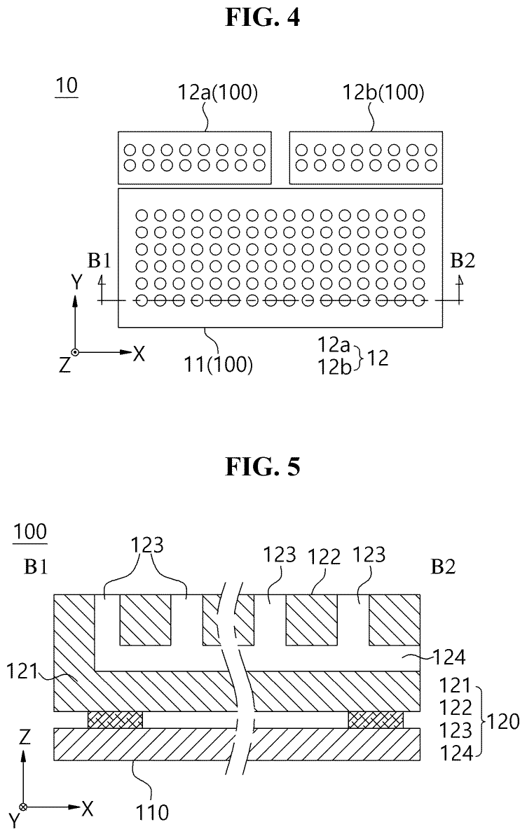

Referring to FIGS. 1 to 3, a process of coupling the material 60 as the film substrate 53 to the display substrate 52 or the FPCB 55 is described. In this process, a plurality of materials 60 may be stacked in a magazine, and one of the plurality of materials 60 may be arranged and aligned to a mount assembly 10 (see FIG. 4).

Thereafter, a PNP unit 20 (see FIG. 7) may transfer the material 60 aligned to the mount assembly 10 (see FIG. 4) and arrange the material 60 so that the material 60 overlaps with the display substrate 52 or the FPCB 55.

In order to arrange the material 60 at a correct position with respect to the display substrate 52 or the FPCB 55, the material 60 needs to be aligned to the mount assembly 10 (see FIG. 4) before the PNP unit 20 (see FIG. 7) transfers the material 60.

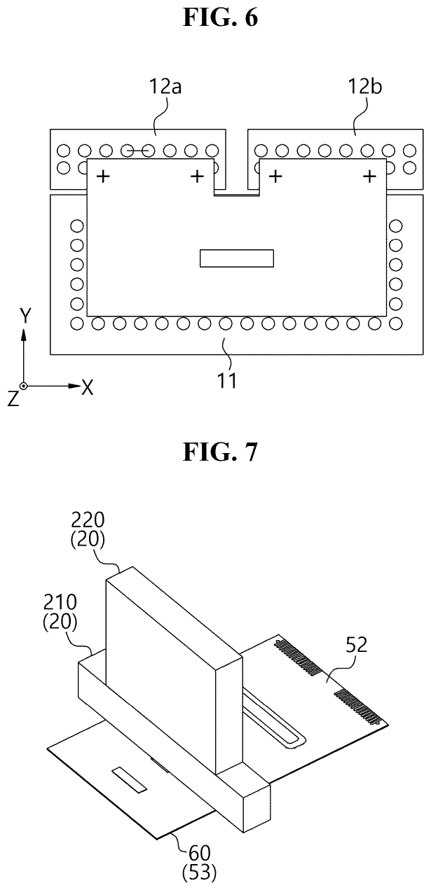

FIG. 4 is a plan view of a mount assembly according to some embodiments of the present disclosure. FIG. 5 illustrates a cross section of the mount assembly illustrated in FIG. 4 taken along the line B1-B2. FIG. 6 illustrates that the material illustrated in FIG. 3 is located on the mount assembly illustrated in FIG. 4.

Referring to FIGS. 4 to 6, a longitudinal direction and a width direction of the mount assembly 10 may correspond to the longitudinal direction and the width direction of the material 60, respectively. For example, the longitudinal direction of the mount assembly 10 may be the same as the longitudinal direction of the material 60. For example, the width direction of the mount assembly 10 may be the same as the width direction of the material 60.

The mount assembly 10 may include a plurality of mount stages 100. The arrangement of the plurality of mount stages 100 may vary depending on the shape of the material 60.

For example, the mount assembly 10 may include a body mount stage 11. The body mount stage 11 may extend in the width direction. The body mount stage 11 may support the material body 61. For example, the material body 61 may be positioned on an upper face of the body mount stage 11.

For example, the mount assembly 10 may include a wing mount stage 12. The wing mount stage 12 may include or indicate at least one of a first wing mount stage 12a or a second wing mount stage 12b.

The wing mount stage 12 may be positioned in front of the body mount stage 11. For example, the first wing mount stage 12a and the second wing mount stage 12b may be arranged in the width direction.

The wing mount stage 12 may support the material wing 62. For example, the first material wing 62a may be positioned on an upper face of the first wing mount stage 12a. For example, the second material wing 62b may be positioned on an upper face of the second wing mount stage 12b.

A structure of the mount stage 100 is described. The mount stage 100 may include a mount stage stand 120. The mount stage stand 120 may include a mount stage stand body 121.

The mount stage stand body 121 may form a block shape. A mount stage stand upper face 122 may be an upper surface of the mount stage stand body 121.

The mount stage stand 120 may include a mount stage stand hole 123. The mount stage stand hole 123 may be a hole formed in the mount stage stand body 121.

For example, the mount stage stand hole 123 may be connected to the mount stage stand upper face 122. For example, the mount stage stand hole 123 may form a recessed shape on the mount stage stand upper face 122. A plurality of the mount stage stand holes 123 may be provided. For example, the plurality of mount stage stand holes 123 may be arranged to be spaced apart from each other.

The mount stage stand 120 may include a mount stage stand suction port 124. The mount stage stand suction port 124 may be a hole formed in the mount stage stand body 121.

For example, the mount stage stand suction port 124 may be connected to at least one of a front face, a rear face, a left face, or a right face of the mount stage stand body 121.

The mount stage stand suction port 124 may communicate with the mount stage stand hole 123. The mount stage stand suction port 124 may be connected to a vacuum pump, etc.

When the vacuum pump operates, air (or gas) positioned in the mount stage stand hole 123 may move toward the mount stage stand suction port 124. For example, when the vacuum pump operates in a state where the material 60 is positioned on the mount stage stand upper face 122, the material 60 may be adsorbed on the mount stage stand 120.

The mount stage 100 may include a mount stage base 110. For example, the mount stage base 110 may be positioned below the mount stage stand 120.

The mount stage base 110 may be connected or coupled to the mount stage stand 120. For example, the mount stage stand 120 may be movably coupled to the mount stage base 110.

For example, the mount stage stand 120 may move up or down with respect to the mount stage base 110. For example, the mount stage stand 120 may move in at least one of the longitudinal direction or the width direction with respect to the mount stage base 110.

For example, the mount stage stand 120 may rotate with respect to the mount stage base 110.

For example, the mount stage stand 120 may rotate in a yaw direction based on the Z-axis with respect to the mount stage base 110.

For example, the mount stage stand 120 may rotate in a roll direction based on the Y-axis with respect to the mount stage base 110.

For example, the mount stage stand 120 may rotate in a pitch direction based on the X-axis with respect to the mount stage base 110.

As the mount stage stand 120 moves or rotates with respect to the mount stage base 110, a position and a posture of the material 60 loaded on the mount stage stand 120 may be aligned.

FIG. 7 illustrates that a PNP unit transfers a material and arranges the material on a display substrate.

Referring to FIG. 7, the PNP unit 20 may include a PNP head 210. The PNP head 210 may be detachably coupled to the material 60 loaded on the mount stage 100 (see FIG. 4).

For example, the PNP head 210 may adsorb the material 60 loaded on the mount stage 100 (see FIG. 4). For example, in a state where the coupling between the mount stage 100 (see FIG. 4) and the material 60 is released, the PNP head 210 may adsorb the material 60. For example, the material 60 may be adsorbed on a lower face of the PNP head 210.

The PNP unit 20 may include a PNP arm 220. The PNP arm 220 may be coupled to the PNP head 210. For example, the PNP arm 220 may form a shape extending upward from the PNP head 210. For example, the PNP arm 220 may be formed integrally with the PNP head 210.

The PNP head 210 may be movably coupled to the PNP arm 220. For example, the PNP head 210 may be movably coupled to the PNP arm 220 in an up-down direction.

The PNP arm 220 may move. For example, the PNP arm 220 may move in the up-down direction. For example, the PNP arm 220 may move in a vertical direction.

The PNP arm 220 may move in a state where the material 60 is adsorbed by the PNP head 210. For example, as the PNP arm 220 moves, the material 60 may be positioned to overlap with the display substrate 52 in the up-down direction.

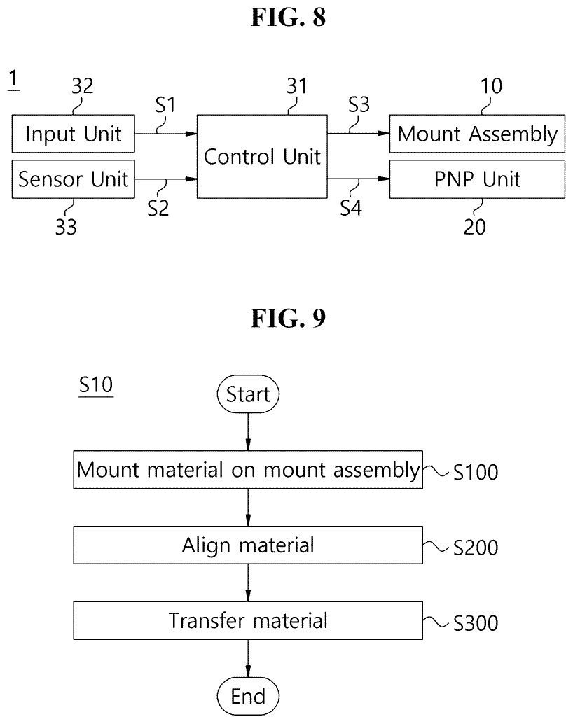

FIG. 8 is a block diagram of a display assembly device according to some embodiments of the present disclosure. Although various components of a display assembly are illustrated in FIG. 8, embodiments according to the present disclosure are not limited thereto, and according to various embodiments, the display assembly may include additional components or fewer components without departing from the spirit and scope of embodiments according to the present disclosure.

Referring to FIGS. 1 to 8, a display assembly device 1 may include the mount assembly 10 and the PNP unit 20. The mount assembly 10 and the PNP unit 20 may operate individually.

The display assembly device 1 may include a control unit 31. The control unit 31 may be implemented through at least one of a processor, a computer, or an electric circuit. The control unit 31 may perform operations. The control unit 31 may process signals. The control unit 31 may transmit and receive the signals.

The display assembly device 1 may include an input unit 32. The input unit 32 may obtain an input from a user, etc. The input unit 32 may generate a first signal S1 and transmit the first signal S1 to the control unit 31. The first signal S1 may include information on operation instructions of the mount assembly 10 and the PNP unit 20.

The display assembly device 1 may include a sensor unit 33. The sensor unit 33 may photograph the material 60. For example, the sensor unit 33 may include a camera. The camera may face the mount assembly 10 from above the mount assembly 10.

For example, the sensor unit 33 may be positioned above the material 60. For example, the sensor unit 33 may obtain an image of the material 60. For example, the sensor unit 33 may obtain an image of a perimeter of the material 60. For example, the sensor unit 33 may obtain an image of the material mark 65 of the material 60.

The sensor unit 33 may generate a second signal S2 and transmit the second signal S2 to the control unit 31. The second signal S2 may include an image of the material 60. For example, the second signal S2 may include an image of at least one of the perimeter of the material 60 or the material mark 65. The second signal S2 may be referred to as a “sensing signal”.

The control unit 31 may generate output signals S3 and S4 based on the input signals S1 and S2. The input signals S1 and S2 may include at least one of the first signal S1 or the second signal S2. The output signals S3 and S4 may include at least one of a third signal S3 or a fourth signal S4.

The control unit 31 may control the mount assembly 10. For example, the control unit 31 may transmit the third signal S3 to the mount assembly 10. The mount assembly 10 may operate in response to the third signal S3. For example, the plurality of mount stages 100 may individually operate in response to the third signal S3.

The third signal S3 may include command information on the operation of the mount assembly 10. For example, the third signal S3 may include information on adjustment of at least one of the position or the posture of the mount stage stand 120 with respect to the mount stage base 110.

The control unit 31 may control the PNP unit 20. The control unit 31 may transmit the fourth signal S4 to the PNP unit 20. The PNP unit 20 may operate in response to the fourth signal S4.

The fourth signal S4 may include command information on the operation of the PNP unit 20. For example, the fourth signal S4 may include command information on the operation of the PNP head 210. For example, the fourth signal S4 may include command information on changes in the position of the PNP head 210 with respect to the PNP arm 220. For example, the fourth signal S4 may include command information on the movement of the PNP arm 220.

FIG. 9 is a flow chart illustrating aspects of a display assembly method according to some embodiments of the present disclosure. Although various operations in a display assembly method are illustrated in FIG. 9, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIGS. 1 to 9, a display assembly method S10 may include a operation S100 of mounting the material 60 on the mount assembly 10. In the operation S100, the control unit 31 may control the PNP unit 20.

For example, in the operation S100, the PNP unit 20 may adsorb and transfer the material 60 loaded on the magazine and load the material 60 on the mount assembly 10. For example, in the operation S100, the material 60 may be positioned on the mount stage stand upper face 122.

The display assembly method S10 may include a operation S200 of aligning the material 60. In the operation S200, the sensor unit 33 may obtain an image of the material 60. In the operation S200, the control unit 31 may control the mount assembly 10.

For example, the mount stage stand 120 may perform a relative movement with respect to the mount stage base 110. The movement of the mount stage stand 120 relative to the mount stage base 110 may include at least one of a translational movement or a rotational movement.

The display assembly method S10 may include a operation S300 of transferring the material 60. In the operation S300, the control unit 31 may control the mount assembly 10. For example, in the operation S300, the coupling between the mount stage stand 120 and the material 60 may be released.

In the operation S300, the control unit 31 may control the PNP unit 20. For example, in the operation S300, the PNP unit 20 may adsorb and transfer the material 60 loaded on the mount stage 100. In the operation S300, the PNP unit 20 may arrange the material 60 so that the material 60 overlaps with the display substrate 52 or the FPCB 55.

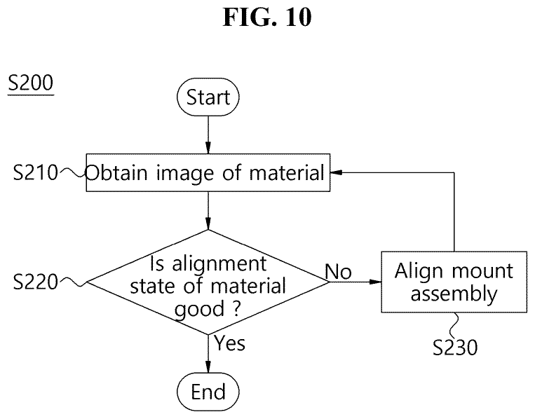

FIG. 10 is a flow chart illustrating aspects of a material alignment operation illustrated in FIG. 9. Although FIG. 10 illustrates various operations in a material alignment operation according to some embodiments, embodiments according to the present disclosure are not limited thereto, and according to various embodiments, the material alignment operation may include additional operations or fewer operations, or the order of operations may vary, unless otherwise stated or implied, without departing from the spirit and scope of embodiments according to the present disclosure.

Referring to FIGS. 1 to 10, a material alignment operation S200 may include a operation S210 in which the sensor unit 33 obtains an image of the material 60. In the operation S210, the control unit 31 may control the sensor unit 33.

The sensor unit 33 may obtain an image of the material 60. For example, the sensor unit 33 may obtain an image of at least one of the perimeter of the material 60 and the material mark 65.

The material alignment operation S200 may include a operation S220 in which the control unit 31 determines whether an alignment state of the material 60 is good. In the operation S220, the control unit 31 may compare the image of the material 60 with a reference image. For example, the control unit 31 may extract a difference between the image of the material 60 and the reference image.

For example, when the difference between the image of the material 60 and the reference image is less than or equal to a reference difference, the control unit 31 may determine that the alignment state of the material 60 is good. In this case, the material alignment operation S200 may end.

For example, when the difference between the image of the material 60 and the reference image exceeds the reference difference, the control unit 31 may determine that the alignment state of the material 60 is not good.

The material alignment operation S200 may include a mount assembly alignment operation S230. After the operation S230 ends, the operation S210 of obtaining the material image may be performed.

If it is determined that the alignment state of the material 60 is not good, the control unit 31 may perform the operation S230. In the operation S230, the control unit 31 may control the mount assembly 10.

For example, in the operation S230, the control unit 31 may control the mount assembly 10 based on the difference between the image of the material 60 and the reference image. For example, in the operation S230, the third signal S3 may be generated based on the difference between the image of the material 60 and the reference image. For example, in the operation S230, the mount assembly 10 may operate in response to the third signal S3.

What is claimed is:

1. A display assembly device comprising:
a body mount stage extending in a width direction; and
a first wing mount stage and a second wing mount stage which are positioned in front of the body mount stage and spaced apart from each other in the width direction,
wherein each of the body mount stage, the first wing mount stage, and the second wing mount stage includes:
a mount stage base; and
a mount stage stand including a mount stage stand body movably coupled to the mount stage base,
wherein the mount stage stand includes a mount stage stand hole recessed on an upper face of the mount stage stand body.

2. The display assembly device of claim 1, wherein the mount stage stand includes a mount stage stand suction port recessed on an outer face of the mount stage stand body and communicating with the mount stage stand hole.

3. The display assembly device of claim 1, wherein the mount stage stand is movably coupled to the mount stage base translationally.

4. The display assembly device of claim 3, wherein the mount stage stand is rotationally coupled to the mount stage base.

5. The display assembly device of claim 4, wherein the mount stage stand is coupled to the mount stage base to enable a rotation in at least one of a roll direction, a yaw direction, or a pitch direction.

6. A display assembly device comprising:
a mount assembly;
a sensor unit above the mount assembly; and
a control unit connected to the mount assembly and the sensor unit,
wherein the mount assembly includes:
a body mount stage extending in a width direction; and
a first wing mount stage and a second wing mount stage in front of the body mount stage and spaced apart from each other in the width direction,
wherein the control unit is configured to control the mount assembly based on a sensing signal received from the sensor unit.

7. The display assembly device of claim 6, wherein the sensor unit includes a camera facing the mount assembly.

8. The display assembly device of claim 7, wherein a material of a film shape is loaded on an upper face of the mount assembly, and
wherein the material includes:
a material body extending in the width direction; and
a first material wing and a second material wing which extend forward from a front end of the material body and are spaced apart from each other.

9. The display assembly device of claim 8, wherein the body mount stage supports the material body,
wherein the first wing mount stage supports the first material wing, and
wherein the second wing mount stage supports the second material wing.

10. The display assembly device of claim 9, wherein a lower face of the material faces the upper face of the mount assembly,
wherein the material includes a material mark marked on an upper face of the material, and
wherein the material mark includes:
a first material mark marked on an upper face of the first material wing; and
a second material mark marked on an upper face of the second material wing.

11. The display assembly device of claim 10, wherein the camera is configured to obtain an image of the material mark.

12. The display assembly device of claim 11, wherein the control unit is configured to control the mount assembly based on a difference between the image of the material mark and a reference image.

13. A display assembly method comprising:
mounting a material of a film shape on a mount assembly;
aligning the material; and
transferring the material,
wherein the mount assembly includes:
a body mount stage extending in a width direction; and
a first wing mount stage and a second wing mount stage which are positioned in front of the body mount stage and spaced apart from each other in the width direction.

14. The display assembly method of claim 13, wherein the material includes:
a material body extending in the width direction and supported by the body mount stage in the mounting of the material;
a first material wing extending forward from a front end of the material body and supported by the first wing mount stage in the mounting of the material; and
a second material wing extending forward from the front end of the material body and supported by the second wing mount stage in the mounting of the material.

15. The display assembly method of claim 14, wherein the first material wing and the second material wing are arranged in the width direction and are spaced apart from each other.

16. The display assembly method of claim 15, wherein a lower face of the material in the mounting of the material faces an upper face of the mount assembly,
wherein the material includes a material mark marked on an upper face of the material, and
wherein the material mark includes:
a first material mark marked on an upper face of the first material wing; and
a second material mark marked on an upper face of the second material wing.

17. The display assembly method of claim 16, wherein aligning the material comprises:
obtaining, by a camera, an image of the material;
determining, by a control unit, whether an alignment state of the material is good; and
controlling, by the control unit, the mount assembly to align the mount assembly.

18. The display assembly method of claim 17, wherein the control unit determines that the alignment state of the material is not good based on a difference between the image of the material and a reference image exceeding a reference difference.

19. The display assembly method of claim 18, wherein the control unit performs aligning the mount assembly based on the difference based on a determination that the alignment state of the material is not good.

20. The display assembly method of claim 18, wherein the control unit ends aligning the material based on a determination that the alignment state of the material is good.
